(19) United States
(12) Patent Application Publication
(10) Pub. No.: US 2005/0131969 A1
(43) Pub. Date: Jun. 16, 2005

(54) Database duplicating method, database duplicating apparatus, database creating method, and database creating apparatus

(75) Inventor: Masaki Nishigaki, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/045,185

(22) Filed: Jan. 31, 2005

Related U.S. Application Data
(63) Continuation of application No. PCT/JP02/10227, filed on Oct. 1, 2002.

(51) Int. Cl. G06F 17/30

(52) U.S. Cl. 707/204

(57) ABSTRACT

A database duplicating apparatus that extracts a data group stored in a database to duplicate a database includes a data extracting unit that sequentially extracts a plurality of data included in the data group; an update monitor that monitors an update status of a data content of the data extracted by the data extracting unit; an update-log storing unit that, when the update monitor detects an update of the data content, stores a content of the update as an update log; and a correcting unit that corrects a content of data extracted by the data extracting unit based on the update log.

### BACKGROUND OF THE INVENTION

1) Field of the Invention

The present invention relates to a database duplicating method and a database duplicating apparatus that extract a data group stored in a database to duplicating database, and a database creating method and a database creating apparatus that create database based upon extracted data, and in particular to a database duplicating method and a database duplicating apparatus that shorten processing exclusion to database to be capable of executing duplication of database and update of database simultaneously.

2) Description of the Related Art

Conventionally, database that manages data in a predefined form concentrically for the purpose of sharing of data pieces, integration of data pieces, and high dependency of individual data pieces. In general, the database is connected to a plurality of terminals via a network or the like, and it manages data pieces that each terminal utilizes unitarily. Therefore, sharing of data pieces at the terminals can be realized by each terminal performing reading and writing desired data piece stored in the database.

When the database is shored by the terminals in this manner, it is necessary to perform exclusion control to avoid double updating of data pieces stored in the database. The exclusion control is a control for disabling the terminals to access the same data piece simultaneously in data management. That is, while a terminal is accessing a data piece stored in the database, another terminal is put in a standby state without receiving access permission until the access of the former terminal is terminated, so that simultaneous updating of the data is prevented. A processing for putting a predetermined data piece in a state where access to the data is not permitted is called “acquirement of exclusion control to data”.

In recent years, utilization value of database increased due to mass volume of database or speeding-up of network, so that backup for the database is regarded as important. It is desirable to reproduce the whole database for backup for the database. However, when data that the database has stored therein is read out in a mass volume such as duplication of the whole database or the like, a time required for reading the data is increased according to the volume of the data to be read out. Here, an action that reads out data from a database for the purpose of duplication or the like is called “extraction of data”. When it takes time for extraction of data in this manner, there is a possibility that modification in contents in database occurs from a duplication start of the database to duplication termination of the database.

When update is permitted without any restriction during duplication of database, a mismatching occurs between a duplication-source database and a destination database. Conventionally, to avoid mismatching between a duplication-source database and a destination database, processing exclusion is acquired to all data pieces included in a duplication source while duplication of the database is being duplicated. That is, in the conventional database duplicating method, there is a problem that it is necessary to stop update of duplication-source database during duplication of the database.

In recent years, however, while a time required for duplication increases according to increase in scale of database, a utilization time of the database increases according to increase in utilization value of the database, so that database that does not stop over 24 hours is required.

### SUMMARY OF THE INVENTION

It is an object of the present invention to solve at least the above problems in the conventional technology.

A database duplicating method according to one aspect of the present invention, which is for extracting a data group stored in a database to duplicate a database, includes extracting sequentially a plurality of data included in the data group; monitoring an update status of a data content of the data extracted; storing, when the update monitor detects an update of the data content, a content of the update as an update log; and correcting a content of data extracted based on the update log.

A database duplicating apparatus according to another aspect of the present invention, which extracts a data group stored in a database to duplicate a database, includes a data extracting unit that sequentially extracts a plurality of data included in the data group; an update monitor that monitors an update status of a data content of the data extracted by the data extracting unit; an update-log storing unit that, when the update monitor detects an update of the data content, stores a content of the update as an update log; and a correcting unit that corrects a content of data extracted by the data extracting unit based on the update log.

A database creating method according to still another aspect of the present invention includes writing sequentially a plurality of data in a database; permitting an update of data whose writing is completed; and performing an update processing on the data whose update is permitted at the permitting.

A database creating apparatus according to still another aspect of the present invention includes a data writing unit that sequentially writes a plurality of data in a database, and permits an update of data whose writing is completed; and an updating unit that performs an update processing on the data whose update is permitted by the data writing unit.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic configuration diagram showing an outline configuration of a database duplicating apparatus according to the present embodiment;

FIG. 2 and FIG. 3 are explanatory diagrams for explaining a database duplicating method;

FIG. 4 is an explanatory diagram for explaining an action of an extraction processor 15;

FIG. 5 is a time chart of an extracting action performed by the extraction processor 15 and monitoring performed by a log monitor 13;

FIG. 6 is an explanatory diagram for explaining of outline configuration of a database creating apparatus 4;

FIG. 7 is an explanatory diagram for explaining a processing action performed by an extraction data processor 42; and

FIG. 8 is an explanatory diagram for explaining a processing action performed by a correction requirement processor 43.

### DETAILED DESCRIPTION

Exemplary embodiments of a database duplicating method and a database duplicating apparatus according to the present invention will be explained below in detail with reference to the drawings.

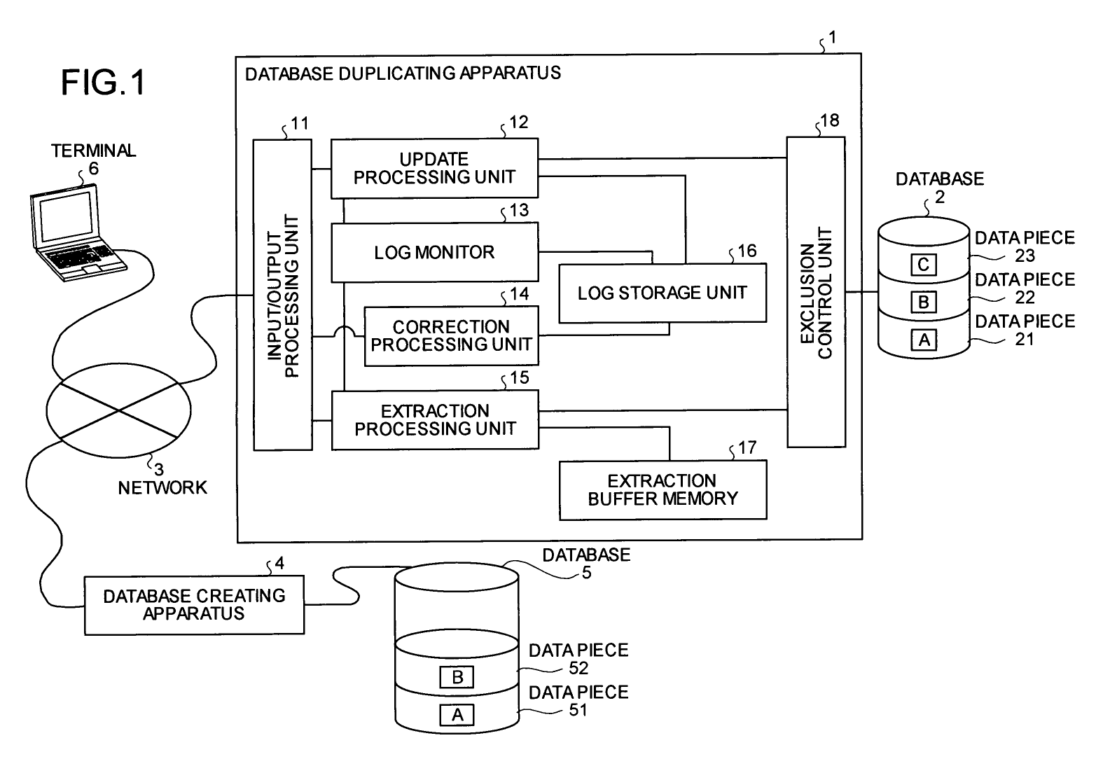

FIG. 1 is a schematic configuration diagram showing an outline configuration of a database duplicating apparatus according to this embodiment. In FIG. 1, a database duplicating apparatus 1 connects a database 2 and a network 3 to each other. Similarly, a database creating apparatus 4 connects a database 5 and the network 3 to each other. The network 3 is connected with a terminal 6.

The database duplicating apparatus 1 has therein an input/output processor 11, an update processor 12, a log monitor 13, a correction processor 14, an extraction processor 15, a log storage unit 16, an extraction buffer memory 17, and an exclusion control unit 18.

The database 2 stores data pieces 21, 22, and 23 therein and the database 5 stores data pieces 51 and 52 therein. Data management in the database 2 and the database 5 is performed using an input/output unit called “page”.

When the terminal 6 updates data stored in the database 2, the terminal 6 accesses the database duplicating apparatus 1 via the network 3. The input/output processor 11 in the database duplicating apparatus 1 transmits access from the terminal 6 to the update processor 12. The update processor 12 acquires processing inclusion of a page storing a desired data piece via the exclusion control unit 18 based upon the access from the terminal 6 to perform reading and writing of a data piece.

On the other hand, when the data stored in the database 2 is extracted and the database 5 is changed to duplication of the database 2, the extraction processor 15 acquires processing exclusion for data to be extracted via the exclusion control unit 18. Next, the extraction processor 15 extracts a desired data piece to release processing exclusion to the data piece. Thereafter, the extraction processor 15 transmits the extracted data piece to the database creating apparatus 4.

Here, the extraction processor 15 acquires only processing exclusion to the page from which data extraction of a data piece is carried out and it does not acquire processing exclusion to the other pages. Accordingly, though the data piece from which the extraction processor 15 is executing extraction is not updated, the other data pieces can be updated arbitrarily.

Specifically, after the extraction processor 15 first acquires processing exclusion to the data piece 21 that the database 2 stores to store the content of the data piece 21 in the extraction buffer memory 17, it releases the processing exclusion to the data piece 21. Next, the extraction processor 15 outputs the content of the data piece 21 stored in the extraction buffer memory 17, here, “A”, to the input/output processor 11. The input/output processor 11 transmits the content “A” of the data piece 21 to the database creating apparatus 4 via the network 3. The database creating apparatus 4 writes the “A” which is the content of the receive data piece 21 as the content of the data piece 51 in the database 5.

After the extraction processor 15 transmits the content of the data piece 21, it acquires processing exclusion to the data piece 22 to store the content of the data piece 22 in the extraction buffer memory 17 and release the processing exclusion to the data piece 22. Thereafter, the extraction processor 15 outputs the content of the data piece 22 stored in the extraction buffer memory 17, here “B”, to the input/output processor 11. The input/output processor 11 transmits the content “B” of the data piece 22 to the database creating apparatus 4 via the network 3. The database creating apparatus 4 writes the “B” which is the content of the received data piece 22 as the content of the data piece 52 in the database 5.

Thus, the extraction processor 15 sequentially acquires processing exclusions to a plurality of data pieces stored in the database 2 to perform extractions of the data pieces.

Accordingly, the update processor 12 can update any data piece other to which a data pieces of which the extraction processor 15 is executing extraction at any time. To prevent mismatching from occurring between the contents of the database 2 and the database 5 due to update that the update processor 12 executes, the log monitor 13 monitors an updating action conducted by the update processor 12.

The mismatching between the contents of the database 2 and the database 5 occurs when a data piece whose extraction from the database 2 has been terminated and which has been transmitted to the database creating apparatus 4, which means, an extracted data piece is updated. Update of a data piece whose extraction has not been performed yet, that is, a non-extracted data piece does not cause mismatching between databases.

Accordingly, when the extraction processor 15 performs extraction of a data piece, the log monitor 13 starts monitoring update to the data piece. When an extracted data piece has been updated, the log monitor 13 stores the content of the update in the log storage unit 16 as an update log.

The correction processor 14 produces a correction request that requests correction of data content based upon the update log to transmit the correction request to the database creating apparatus 4 via the input/output processor 11. When the database creating apparatus 4 receives the correction request, it performs correction of the data content in the database 5. Accordingly, when the update processor 12 performs update on the extracted data piece, the update content is transmitted to the database creating apparatus 4 as a correction request and the correction request is reflected on the database 5, so that synchronization between contents of data pieces can be achieved.

When an update request is issued to a data piece to which the extraction processor 15 has acquired processing exclusion, the update processor 12 stores update content of the update request to the log storage unit 16 and it performs update after the extraction processor 15 releases processing exclusion. That is, when the extraction processor 15 performs access to a data piece to be update-processed, the update processor 12 uses the log storage unit 16 as a temporary storage region.

Accordingly, the log storage unit 16 is used for both storage of an update log stored by the log monitor 13 and a temporary storage performed by update processor 12. Here, the correction processor 14 handles the temporary storage that the update processor 12 has performed in the same manner as the update log and it issues a correction request based upon the temporary storage which the update processor 12 has recorded. Thus, by handling the temporary storage which the update processor 12 forms as the update log, necessity that the log monitor 13 forms an update log independently is excluded, so that a storage volume to be used can be reduced.

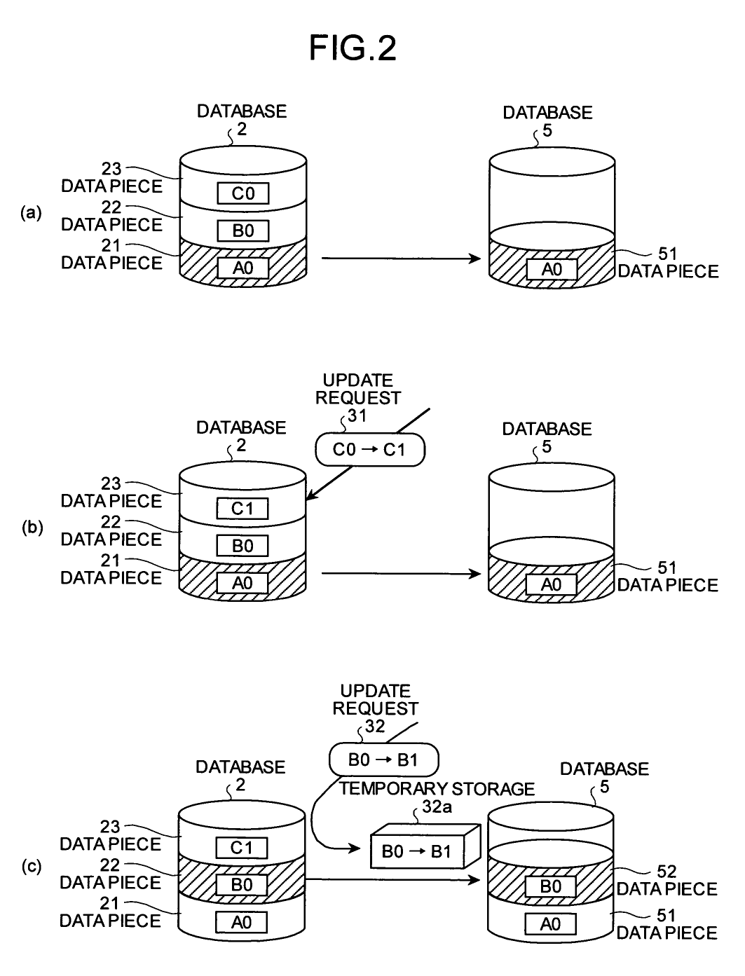

When the content of the database 2 is duplicated to the database 5, as shown in FIG. 2A, the extraction processor 15 first acquires processing exclusion to the data piece 21 in the database 2 and reads the data piece 21 to transmit the same to the database creating apparatus 4. Next, the database creating apparatus 4 acquires processing exclusion to the data piece 51 in the database 5 and performs writing. Accordingly, the content of the data piece 51 is changed to the same “A0” as that of the data piece 21.

In the database 2, since the exclusion processing is selectively acquired to the data piece 21, the data piece 22 and the data piece 23 can be updated. Therefore, as shown in FIG. 2B, when an update request 31 for rewriting the content of the data piece 23 from “C0” to “C1” occurs, the content of the data piece 23 is rewritten to “C1”.

After the content of the data piece 21 is duplicated to the data piece 51, as shown in FIG. 2C, the processing exclusions to the data piece 21 and the data piece 51 are released and processing exclusion to the data piece 22 is acquired. Next, the extraction processor 15 reads the data piece 22 to transmit the same to the database creating apparatus 4. The database creating apparatus 4 acquires processing exclusion to the data piece 52 to perform writing therein. Therefore, the content of the data piece 52 is changed to the same “B0” as that of the data 22.

When an update request 32 for rewriting the content of the data piece 22 from “B0” to “B1” during extraction of the data piece 22, since the extraction processor 15 has acquired the processing exclusion to the data piece 22, the data piece 22 can not be updated. Therefore, the update processor 12 stores the update request 32 in the log storage unit 16 as a temporary storage 32b.

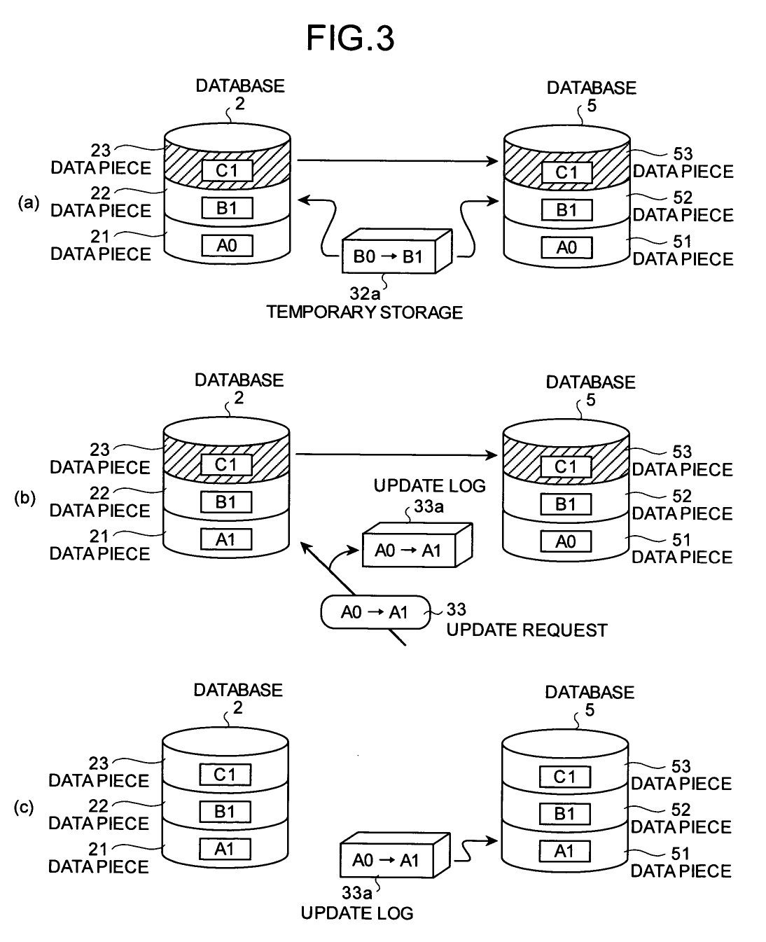

After the content of the data piece 22 is duplicated, as shown in FIG. 3A, the processing exclusions to the data piece 22 and the data piece 52 are released. Since the processing exclusion to the data piece 22 is released, the update processor 12 rewrites the content of the data piece 22 from “B0” to “B1” using the temporary storage 32b. The correction processor 14 transmits a correction request to the database creating apparatus 4 based upon the temporary storage 32b to rewrite the content of the data piece 52 from “B0” to “B1”.

Next, the extraction processor 15 acquires processing exclusion to the data piece 23 and reads the data piece 23 to transmit the data piece to the database creating apparatus 4. The database creating apparatus 4 acquires processing exclusion to the data piece 53 to perform writing therein. Therefore, the content of the data piece 53 is changed to the same “C1” as that of the data piece 23.

When an update request for writing the content of the data piece 21 from “A0” to “A1” is generated during duplication of the data piece 23, as shown in FIG. 3B, since the processing exclusion to the data piece 21 has been released, the update processor 12 rewrites the content of the data piece 21 from “A0” to “A1”. Here, since the data piece 21 has been extracted by the extraction processor 15, the log monitor 13 stores the update content of the data piece 21 in the log storage unit 16 as an update log 33a.

As shown in FIG. 3C, the correction processor 14 transmits a correction request to the database creating apparatus 4 based upon the update log 33a to rewrite the content of the data 21 from “A0” to “A1”. Therefore, the content of the database 5 reflects update of the database 2, so that identity in content between the database 2 and the database 5 can be secured.

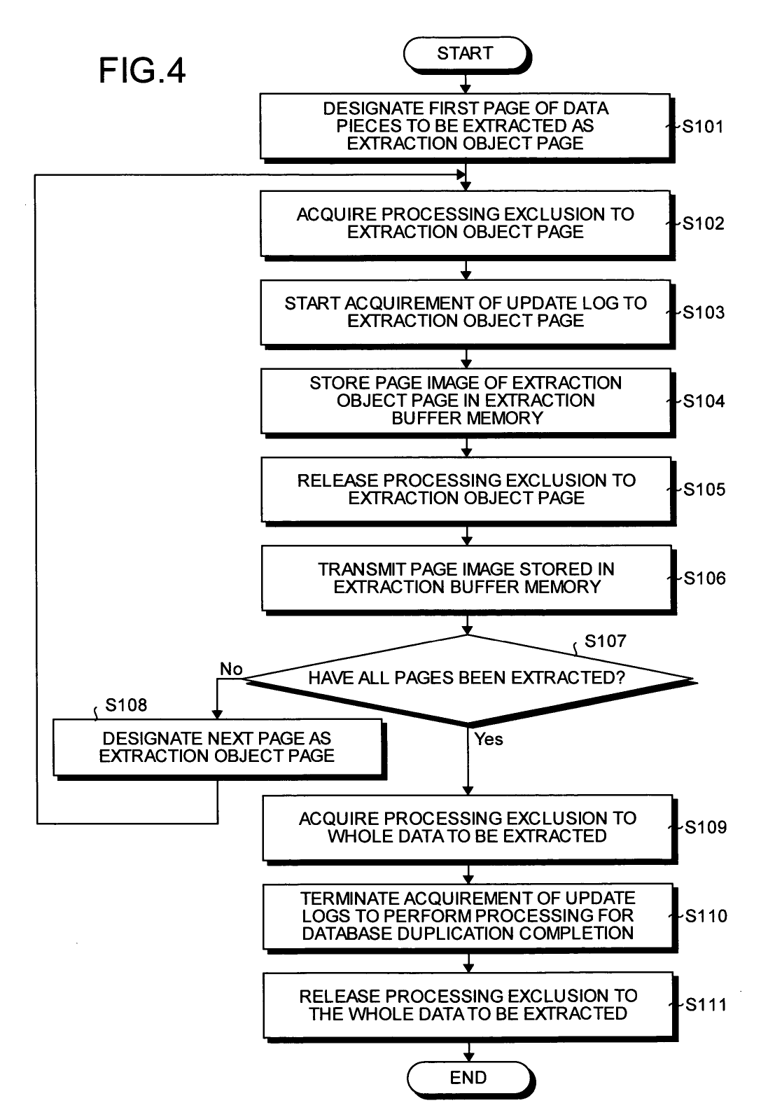

Next, as shown in FIG. 4, an action of the extraction processor 15 will be explained in detail with reference to FIG. 4. When the database 2 is duplicated, the extraction processor 15 first the first page in data to be extracted as an extraction object page (Step S101). Next, the extraction processor 15 acquires processing exclusion to the extraction object page (Step S102) to start acquirement of an update log of the extraction object page (Step S103).

Thereafter, the extraction processor 15 stores a page image of the extraction object page, namely, content of the data that the extraction object page stores in the extraction buffer memory 17 (Step S104) and releases the processing exclusion to the object extraction page (Step S105).

Subsequently, the extraction processor 15 the page image stored in the extraction buffer memory 17 to the database creating apparatus 4 (Step S106). Here, the extraction processor 15 determines whether it has extracted all pages, namely, it has completed extractions of all data pieces (Step S107).

When there is a data piece which has not been extracted yet (step S107, No), the extraction processor 15 designates the next page as extraction object page (Step S108) to acquire processing exclusion to the extraction object page (Step S102).

On the other hand, when all the pages have been extracted (Step S107, Yes), the extraction processor 15 acquires processing exclusion to the whole data to be extracted (Step S109). Next, after acquirement of update log is terminated and a processing for database duplication completion is performed (Step S110), the processing exclusion to the whole data is released (Step S111) and the processing action is terminated.

When the duplication-source database 2 serves as a main database, and the destination database 5 serves as a backup database, a database to which the terminal 6 accesses after duplication of the database is the database 2. In that case, an action for database duplication completion may be performed so as to terminate monitoring performed by the log monitor 13 and continue updating processing performed by the update processor 12.

On the other hand, when the duplication-source database 2 serves as a backup database and the destination database 5 functions as a main database, that is, the duplication of the database is a recovery from the backup database, a database that the terminal 6 accesses after duplication of the database is the database 5. Accordingly, as the processing for the database duplication terminal performed in that case, it is necessary to terminate updating action performed by the update processor 12 to perform a processing for switching of access target of the terminal 6.

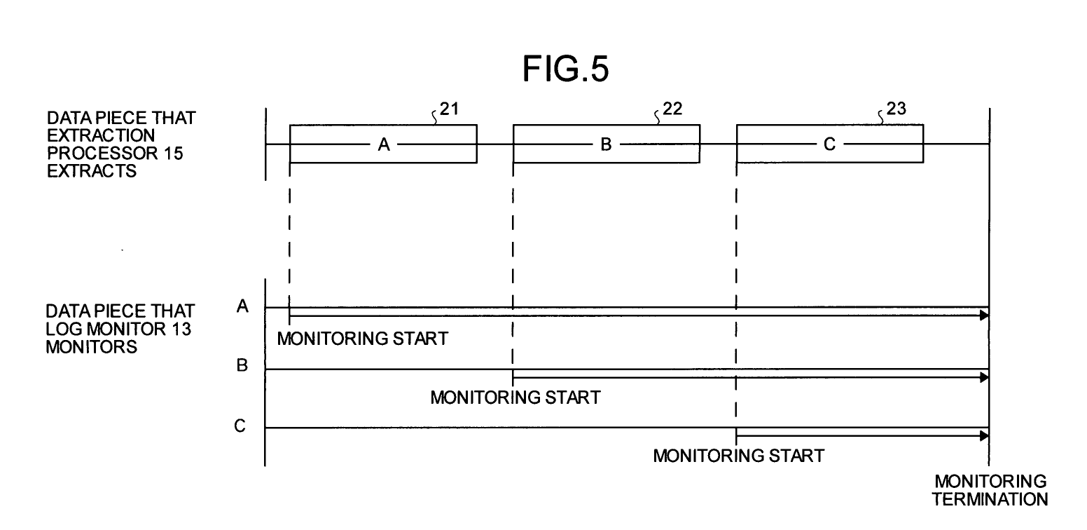

The log monitor 13 monitors update of the data piece to which an extraction processing conducted by the extraction processor 15 has been completed. Therefore, each time when the extraction processor 15 extracts a data piece, the number of data pieces which should be monitored by the log monitor 13 is increases. FIG. 5 shows a flowchart showing a timing chart of an extraction action performed by the extraction processor 15 and monitoring performed by the log monitor 13.

As shown in FIG. 5, when the extraction processor 15 starts extraction of the data piece 21, monitoring of the data piece 21 performed by the log monitor 13 continues after the extraction processor 15 completes the extraction of the data piece 21. When the extraction processor 15 starts extraction of the data piece 22, the log monitor 13 adds the data piece 22 to the monitor object. Therefore, the log monitor 13 monitors both the data piece 21 and the data piece 22 at that time.

When the extraction processor 15 completes extraction of the data piece 22 and starts extraction of the data piece 23, the log monitor 13 starts monitoring of the data piece 23. Thus, the number of data pieces which constitutes the monitor object of the log monitor 13 increases. Regarding the monitoring of these data pieces, the log monitor 13 monitors all data pieces just before completion of duplication, because termination of the database duplication is collectively performed at a time of duplication completion of database.

When an update of a data piece is performed during execution of the monitoring, an update content thereof is stored in the log storage unit 16 as an update log. The update log may be discarded arbitrarily after a correction request is issued by the correction processor 14 and a update content is reflected in the database 5. Since issue of a correction request performed by the correction processor 14 is performed each time when an update log is formed, the log storage unit 16 can reduce a storage capacity to be used to the minimum necessary without requiring a long time accumulation of an update log.

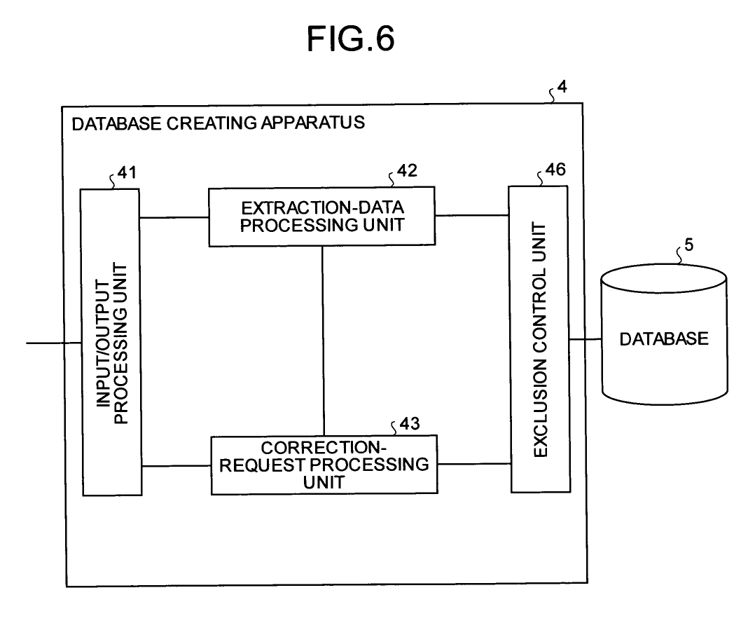

FIG. 6 is an explanatory diagram for explaining a schematic configuration of the database creating apparatus 4. The database creating apparatus 4 includes therein an input/output processor 41, an extraction data processor 42, a correction request processor 43, and an exclusion control unit 46.

When the input/output processor 41 receives a page image that the extraction processor 15 extracts, namely, an extraction data piece, it outputs the received extraction data piece to the extraction data processor 42. When the input/output processor 41 receives a correction request that the correction processor 14 transmits, it sends the correction request to the correction request processor 43.

When the extraction data processor 42 receives the extraction data piece, it acquires processing exclusion to the database 5 via the exclusion control unit 46 and writes the content of the extraction data piece into the database 5. When the extraction data processor 42 receives the extraction data piece, it instructs the correction request processor 43 to start a correction processing.

The correction request processor 43 starts reception of the correction request according to the instruction form the extraction data processor 42. Thereafter, when receiving the correction request, the correction request processor 43 acquires processing exclusion to the database 5 via the exclusion control unit 46 to reflect the content of the correction request in the database 5.

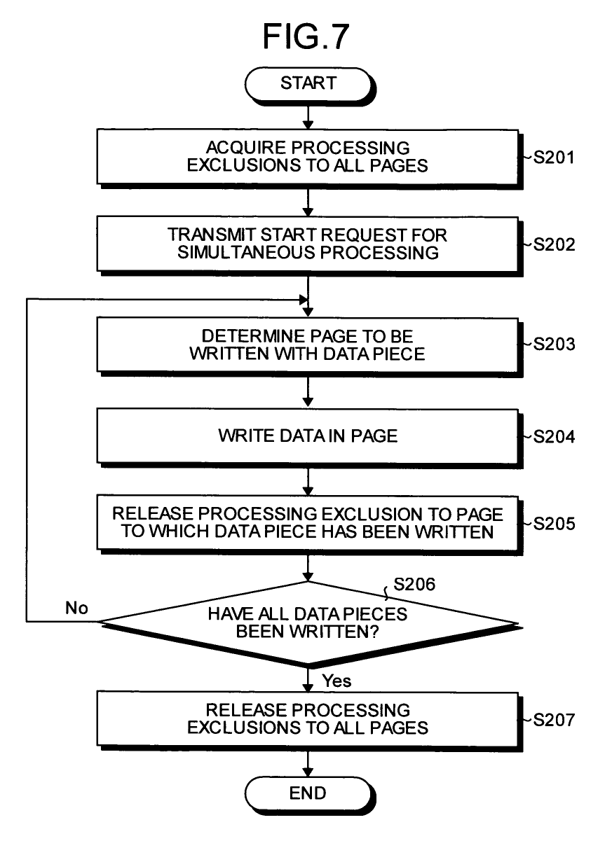

Here, a processing action of the extraction data processor 42 will be explained specifically with reference to FIG. 7. In FIG. 7, the extraction data processor 42 first acquires processing exclusions to all pages of the database 5 (Step S201). Next, the extraction data processor 42 transmits a start request for correction processing to the correction request processor 43 (Step S202). Subsequently, the extraction data processor 42 determines a data writing position in the database 5 (Step S203).

The determination of the data writing position is for determining a place where duplication of a page image included in the received extraction data piece is produced. If a necessary page is already present in the database 5, a position to be written is selected from the present page, while a necessary page is produced when the necessary page is not present in the database 5.

Next, the extraction data processor 42 performs data writing into a page (Step S204) to produce duplication of a page image. Subsequently, the extraction data processor 42 releases the processing exclusion to (Step S205) the page to which the data writing has been terminated.

Thereafter, the extraction data processor 42 determines whether writing of all the data pieces have been terminated (Step S206), and the extraction data processor 42 terminates the processing, when writing of all of the data pieces has been terminated (Step S206, Yes). On the other hand, when a data piece(s) whose writing has not been terminated is left (Step S206, No), the extraction data processor 42 determines a page (Step S203) to which the data piece(s) should be written to continue the processing.

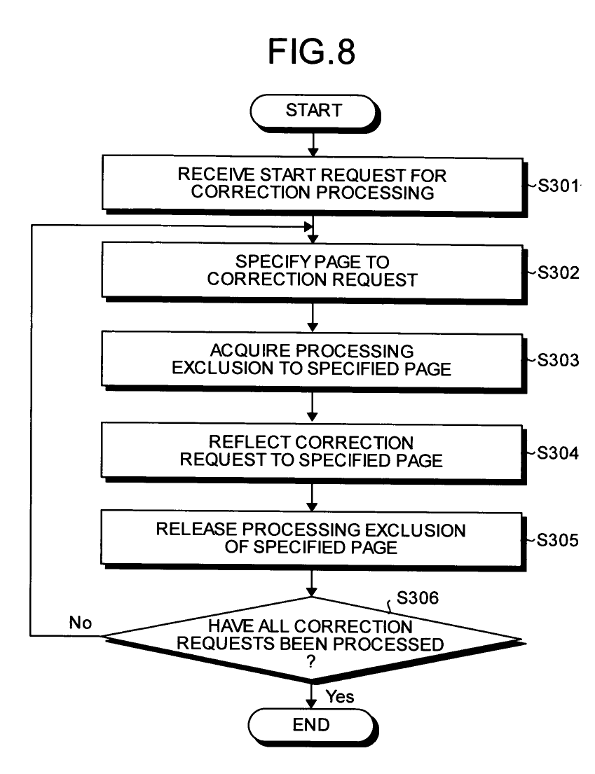

Next, the processing action of the correction request processor 43 will be explained specifically with reference to FIG. 8. In FIG. 8, the correction request processor 43 first receives a start request for correction processing from the extraction data processor 42 to start reception of a correction request (Step S301). Next, the correction request processor 43 specifies a page corresponding to the correction request received from the database 5 (Step S302) to acquire processing exclusion to the specified page (Step S303).

Subsequently, the correction request processor 43 performs data writing based upon the content of the correction request to reflect the content of the correction request in the database 5 (Step S304). Thereafter, the correction request processor 43 releases the processing exclusion to the page to which the correction processing has been terminated (Step S305).

Next, the correction request processor 43 determines whether processings to all the correction requests have been terminated (Step S306), and it terminates the processing action when the processing to all the correction requests have been terminated (Step S306, Yes). On the other hand, when a correction request(s) to which a processing has not been terminated yet is left (Step S306, No), the correction request processor 43 moves to Step S302 again and continues the processing action.

In the database creating apparatus 4, the extraction data processor 42 sequentially releases the processing exclusions to the pages to which data writing has been terminated. Accordingly, the correction request processor 43 performs a correction processing of a database in parallel with re-establishment of a database performed by the extraction data processor 42.

As described above, when duplication of a database is performed, the database duplicating apparatus 1 according to the present embodiment acquires a processing exclusion to only a data piece put under execution of extraction, further monitor update to the extracted data piece to produce an update log and issues a correction request based upon the update log to reflect update to the database 2 in the database 5, the database duplicating apparatus 1 can perform a extraction processing and an update processing in parallel and can create duplication of a database without stopping update of the database.

A temporary storage for updating the database 2 and an update log for simultaneous processing of the database 2 and the database 5 together are stored in the log storage unit 16 so that an apparatus configuration is simplified. Further, the correction processor 14 handles a temporary storage for updating the database 2 as an update log so that a storage capacity to be used is reduced to the minimum necessary by excluding a necessity that the log monitor 13 forms an update log independently.

Further, in the database creating apparatus 4, since the extraction data processor 42 sequentially releases the processing exclusions to the pages to which data writing has been terminated, synchronization processing of the database can be performed in parallel with re-establishment of a database performed by the extraction data processor 42.

According to the present embodiment, for simplification of explanation, such an explanation is made that data pieces stored in the database 2 are the data pieces 21 to 23, but the description is not for defining a data storage system and a data amount of the database 2. The present invention is applicable to a database of any system and any data amount.

According to the present embodiment, connection of the database duplicating apparatus 1 is made using the database 2 as a duplication-source database and connection of the database creating apparatus 4 is made using the database 5 as a duplicated database. However, by further adding the extraction data processor 42 and the correction request processor 43 that the database creating apparatus 4 includes to the database duplicating apparatus 1, a database duplicating apparatus that allow duplication and creation of a database can be obtained.

According to the present embodiment, the database duplicating apparatus that is especially suitable for implementing the database duplicating method has been explained, but the present invention can be implemented as a database duplicating program that can be executable on any computer terminal by realizing the functions shown according to the present embodiment with a software.

As explained above, according to the present invention, by sequentially extracting a plurality of data pieces that a database stores therein, monitoring update of data content to a data piece whose extraction has been terminated, storing update content as an update log when the extracted data piece is updated, and correcting the content of the extracted data piece based upon the update log, the content of the extracted data piece can be kept in the latest state. Accordingly, such an advantage can be achieved that a database duplicating method and a database duplicating apparatus that shorten processing exclusion to the entire database and can simultaneously perform duplication of a database and update of a database can be provided.

Furthermore, according to the present invention, by transmitting an extracted data piece to a duplication target database connected via a network and transmitting a correction request to a duplication target database via a network, data contents between the databases connected to the networks can be synchronized. Accordingly, in duplication of a database via the network, such an advantage can be achieved that a processing exclusion to a database can be shortened and duplication of a database and update of a database can be performed simultaneously.

Moreover, according to the present invention, since a processing exclusion to a data piece put during extraction is selectively acquired and processing exclusions to an extracted data piece and a data piece before extracted are released, such an advantage can be achieved that a database duplicating method and a database duplicating apparatus that can shorten processing exclusion to a database to simultaneously perform duplication of a database and update of a database can be provided.

Furthermore, according to the present invention, since, when a data piece put during extraction is updated, the content of the update is temporarily stored and the update is performed after the extraction is terminated, such an advantage can be achieved that a database duplicating method and a database duplicating apparatus that can shorten processing exclusion to a database to simultaneously perform duplication of a database and update of a database can be provided.

Moreover, according to the present invention, since regarding update generated to a data piece put during extraction, a correction request is issued based upon temporary storage of the content of the update, such an advantage can be achieved that a database duplicating method and a database duplicating apparatus that can shorten processing exclusion to a database to simultaneously perform duplication of a database and update of a database can be provided.

Furthermore, according to the present invention, since an update log and the content of the update stored in the temporary storing unit are stored in the same storage region and the storage region can be shared in this manner, such an advantage can be achieved that a database duplicating method and a database duplicating apparatus that can shorten processing exclusion to a database to simultaneously perform duplication of a database and update of a database, and has a reduced storage region to be used can be provided.

Moreover, according to the present invention, since, when a plurality of data pieces are sequentially written in a database, processing exclusions to data pieces whose writing has been terminated are sequentially released and the data piece whose writing has been terminated can be updated, a database creating method and a database creating apparatus that can shorten processing exclusion to a database to perform establishment of a database and synchronization of databases in parallel.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A database duplicating method of extracting a data group stored in a database to duplicate a database, the database duplicating method comprising:
extracting sequentially a plurality of data included in the data group;
monitoring an update status of a data content of the data extracted;
storing, when the update monitor detects an update of the data content, a content of the update as an update log; and
correcting a content of data extracted based on the update log.

2. The database duplicating method according to claim 1, wherein
the extracting includes transmitting the date extracted to a destination database that is connected via a network, and
the correcting includes transmitting a correction request for the data corresponding to the update log to the destination database.

3. The database duplicating method according to claim 1, further comprising:
prohibiting an update of data under extraction at the extracting; and
permitting an update of data after the extraction and an update of data before the extraction.

4. The database duplicating method according to claim 3, further comprising storing temporarily, when there is an update of data content in the data whose update is prohibited at the prohibiting, the update of the data content.

5. The database duplicating method according to claim 4, wherein the correcting includes handling an update content stored at the storing temporarily as the update log.

6. A database duplicating apparatus that extracts a data group stored in a database to duplicate a database, the database duplicating apparatus comprising:
a data extracting unit that sequentially extracts a plurality of data included in the data group;
an update monitor that monitors an update status of a data content of the data extracted by the data extracting unit;
an update-log storing unit that, when the update monitor detects an update of the data content, stores a content of the update as an update log; and
a correcting unit that corrects a content of data extracted by the data extracting unit based on the update log.

7. The database duplicating apparatus according to claim 6, wherein
the data extracting unit transmits the date extracted to a destination database that is connected via a network, and
the correcting unit transmits a correction request for the data corresponding to the update log to the destination database.

8. The database duplicating apparatus according to claim 6, further comprising an exclusion control unit that prohibits an update of data under extraction by the data extracting unit, and permits an update of data after the extraction and an update of data before the extraction.

9. The database duplicating apparatus according to claim 8, further comprising a temporary storing unit that, when there is an update of data content in the data whose update is prohibited by the exclusion control unit, temporarily stores the update of the data content.

10. The database duplicating apparatus according to claim 9, wherein the correcting unit handles an update content stored in the temporary storing unit as the update log.

11. The database duplicating apparatus according to claim 10, wherein the update content to be stored in the temporary storing unit and the update log are stored in same storage area.

12. A database creating method comprising:
writing sequentially a plurality of data in a database;
permitting an update of data whose writing is completed; and
performing an update processing on the data whose update is permitted at the permitting.

13. A database creating apparatus comprising:
a data writing unit that sequentially writes a plurality of data in a database, and permits an update of data whose writing is completed; and
an updating unit that performs an update processing on the data whose update is permitted by the data writing unit.
